(19) United States
(12) Patent Application Publication
(10) Pub. No.: US 2005/0217892 A1
(43) Pub. Date: Oct. 6, 2005

(54) Electronic device provided with a power supply cord securement structure

(75) Inventors: Yoshiaki Takahashi, Takefu-city (JP); Tomoyuki Harada, Takefu-city (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: ORION ELECTRIC CO., LTD.,, Takefu-city (JP)

(21) Appl. No.: 11/093,233

(22) Filed: Mar. 30, 2005

(30) Foreign Application Priority Data
Mar. 31, 2004 (JP) 2004-103864

(51) Int. Cl. H05B 37/00

(52) U.S. Cl. 174/135

(57) ABSTRACT

To provide a power supply cord securement structure in order to finalize simple securement without incurring cost as much as possible when embedding the structure into the device body as a final product while the power supply cord connected to the electronic device is detachably secured in the assembly process, to prevent stress related cutting and wear due to transfer during the assembly process and transport between factories.

In a power supply cord securement structure to secure and constrain the bush 14 by providing a nearly L shaped notch 12b on the chassis wall 12a where another electronic device 16 embedded into the electronic device and the electronic circuit substrate 17 provided on the electronic device main body are mounted, detachably securing the power supply cord with a securement structure in which the depressed section 14a close to the bush 14 of the power supply cord 13 is inserted, and obstructing the open side of the securement structure by edge 11a of the open section 11 formed on the body wall of the electronic device in the final assembly process of the electronic device.

The present application is based on and claims priority of Japanese patent application No. 2004-103864 filed on Mar. 31, 2004, the entire contents of which are hereby incorporated by reference.

### BACKGROUND OF THE INVENTION

1. Field of the Invention

The present invention relates to an electronic device that provides a power supply cord securement structure where securing the power supply cord can be performed easily, preventing cutting or wear that may occur between manufacturing processes or at the time of transport between factories, by especially arranging the location and shape of the power supply cord securement structure on an electronic device.

Conventionally, Japanese Laid-Open Patent Publication 10-205657 discloses a structure for securing the power supply cord on an electronic circuit substrate. The disclosed power supply cord securement structure comprises:
a lower body 10e that has an opening at the top, and
an upper body 10d that covers, from the top, the notch 12b where the interior side is wider in nearly an L shape and having the opening section at the wall edge of the lower body, or a wide notch (illustration omitted) where the interior side is wider toward the end; and a nearly rectangular depression where a cross section provided in the vicinity of nearly the center thickness direction of the bush provided at the power supply cord 13 is inserted from the narrow width direction of the bush, and when the bush reaches the interior of the notch, slipping off is prevented by rotating the bush to an angle of 90 degrees to the wide width section of the interior side, further free rotation of the bush being suppressed and secured by the interposition of the projecting wall 18a provided at the lower body and the upper body 10d of the cover.

However, the vicinity of the notch 12b has a complex structure, such as the wall thickness 18b, and the wall protrusion 18a, with the problem of requiring an expensive metallic mold. Since the power supply cord 13 is secured by twisting the bush to an angle of 90 degrees to the body, the twisted cord extends to the soldered joint of the power supply cord and the closely proximate electronic circuit substrate (illustration omitted). There is concern that this may lead to the deterioration of the secured strength and the joint security of the power supply cord 13. Since, at the time of finishing the product, a securement structure is commonly provided on the body of an assembled electronic device, the power supply cord has not been secured during the assembly stage or during transfer and transport between factories.

2. Description of the Related Art

Prior art that relates to such a secured power supply cord structure is disclosed in Japanese Laid-Open Patent Publication 11-191683. However securement is temporarily accomplished on the electronic circuit substrate close to the power supply cord by using the cooling plate used for cooling electronic parts to temporarily secure the power supply cord only during the time of the distribution process. The power supply cord needs to be removed from the temporary fixture and secured again to a separately provided securement structure at the time of final product assembly.

Patent Reference 1:
Japanese Laid-Open Patent Publication H10-205657

Patent Reference 2:
Japanese Laid-Open Patent Publication H11-191683

### SUMMARY OF THE INVENTION

It is an objective of the present invention to provide an electronic device endowed with a power supply cord securement structure capable of preventing slipping off of and wear and damage to the power supply cord that may occur between the manufacturing processes during the assembly of electronic devices, or at the time of transport between factories. The objective is to particularly provide an electronic device endowed with a power cord securement structure capable of preventing slipping off as well as any cutting that may occur due to the transfer during the assembly process, or during transport between factories. A further special securement structure is not required in the assembly process of final assembly of the product, and simple securement may be accomplished even for the final product by utilizing a structure to secure the power supply cord during the assembly process, without the need to use the cooling plate, used to cool the electronic parts, as a temporary securing component of the power supply cord in locations close to the power supply cord on the electronic circuit substrate, and without the need to provide a power supply cord securement structure with a separate electronic device body at the time of the final product assembly, and no man-hours are required to secure the power cord.

In order to achieve the above objective, the present invention is provided with a power supply cord securement structure which can be detachably secured on the wall of the chassis where the electronic circuit substrate is mounted, the power supply cord being secured by obstructing the release component side of the securement structure by the edge of the opening formed on the body wall of the electronic device.

Claim 1 of the present invention is a method of securing the power supply cord used for an electronic device, which provides the use of a nearly L shaped notch formed on the wall of the chassis for mounting the electronic circuit substrate, the power supply cord bush connected to the electronic circuit substrate being detachably secured by its insertion into the notch.

According to the construction of claim 1 of the present invention, a nearly L shaped notch is pre-formed on the wall of the chassis where the electronic circuit substrate such as that of a television image receiver, video device, DVD device or the like is mounted. The electronic circuit substrate to which the power supply cord is connected is then assembled as a unit with the chassis. By securing the power supply cord bush by inserting it through the notch provided on the chassis wall, a securement structure can be obtained in which stress related cutting and wear of the power supply cord caused by pulling the power supply cord out from the electronic circuit substrate can be prevented during transport between factories and during transfer during processing, without first being forcibly twisted.

Claim 2 of the present invention comprises a relational formula where x and a are generally 1.2 a=x=2 a, and preferably 1.4 a=x=1.7 a and preferably x is approximately equal to 1.6 a with the relationship where y is approximately equal to b, and with the relationship of b+c=z when the lateral measurement of the nearly L shaped notch formed on the chassis wall is x, the vertical measurement of the opening side opposite edge is z, the vertical measurement of the interior opposite side is y, the lateral measurement of the concave part equipped in the vicinity of the power supply cord bush inserted through this notch is a, the vertical measurement is b, and the supporting brim height measurement is C.

According to the construction of claim 2 of the present invention, the bush is inserted vertically as far as the base of the notch having the relationship of b+c=z along the opening side opposite edge surface of the notch of the chassis, and then, the notch where the lateral measurement of the notch x is formed wider in relation to the lateral measurement of the concave part of the bush a with the relationship of generally 1.2 a=x=2 a, and preferably 1.4 a=x=1.7 a and preferably x is approximately equal to 1.6 a, is laterally inserted. The bush that reaches to the interior side opposite edge surface comprising the deepest part, can be secured without being easily removed even under the stress sustained during transfer between processes and transport between factories without the power supply cord first being twisted, by lightly obstructing it in a relationship in which y is approximately equal to b between the upper part and the base of the notch.

Claim 3 of the present invention relates to the securement structure of a power supply cord used for an electronic device wherein the chassis where the power supply cord bush inserted according to claim 1 and claim 2 is mounted on the body of the electronic device, and where the bush is constrained by obstructing the release direction of the notch formed on the chassis by the edge of the opening formed in the body wall of the electronic device, thereby preventing the bush from slipping out.

According to the construction of claim 3 of the present invention, a securement structure of a power supply cord can be obtained where the supporting brim of the power supply cord bush is easily obstructed and constrained at the opening edge surface of the body by embedding the chassis into the body of the electronic device for a power supply cord secured to the nearly L shaped notch provided on the wall of the chassis in a step prior to its being embedded in the body of the electronic device.

By the construction of claim 1 and claim 2 of the present invention, an AV jack terminal used for connection to the power supply cord or other electronic devices and a ground terminal are commonly arranged on the body wall in various electronic devices. Because there is a great loss in assembly work performance by arranging these terminals on the wall of the body and connecting them to the electronic circuit substrate later, an opening is often provided in the part of the wall of the body where the terminals are exposed, the terminals being pre-embedded in the wall of a chassis located in the same direction as the body wall. The present invention also provides a nearly L shaped notch formed at the wall of the chassis in order to secure the power supply cord. Next, the electronic circuit substrate connected to the power supply cord is embedded in the chassis to become a single unit. By inserting the bush arranged on the power supply cord into the notch provided on the chassis wall, the power supply cord can be easily detached without twisting the power supply cord or using a cooling plate to cool the electronic parts, thereby preventing stress related cutting and wearing of the power supply cord that occurs during transfer between the assembly processes or during transport between factories. A securement structure power supply cord structure can be obtained with no concern of lowering the cooling performance when the cooling plate is used for securement, with no necessity of raising the costs by enlarging the electronic device or the cooling plate to compensate for the above problems, and no need to arrange a power transistor corresponding to a cooling plate sufficient to secure the power supply cord in a closely proximate location on the electronic circuit substrate.

In the construction of claim 3 of the present invention, the power supply cord is detachably secured on the chassis wall in the stage prior to being embedded into the body of the electronic device, and securement can be accomplished by embedding it into the body subsequent to having the supporting brim of the power supply cord bush constrained by the opened edge of the body. By so doing, the power supply cord can be secured all at once, making it possible to reduce the operating man-hours required in the final stage of product assembly to secure the power cord and the body of the separate electronic device. Further, obstructing the supporting brim of the bush by the edge of the body opening is a simple, easily formed structure, which makes possible a less expensive mold. If, for some reason, the chassis and the electronic circuit substrate need to be detached, the interior of the body may be exposed by only taking apart the embedded body portion, and the power supply cord can be detachably secured to the notch of the chassis wall.

### BRIEF DESCRIPTION OF THE DRAWINGS

FIG. 1 illustrates a preferred Embodiment of the present invention, which is an explanatory drawing showing the arrangement of the power supply cord and terminals and so forth on the rear surface of the television image receiver.

FIG. 2 is the same as above, and is an explanatory drawing showing a magnified diagonal view of the bush arranged on the power supply cord.

FIG. 3 is the same as above, and is an explanatory drawing showing the state prior to attaching the power supply cord bush on the chassis wall.

FIG. 4 is the same as above, and is an explanatory drawing showing the state of the attachment process of the power supply cord bush on the chassis wall.

FIG. 5 is the same as above, and is an explanatory drawing showing the state following the attachment of the power supply cord bush to the chassis wall.

FIG. 6 is the same as above, and is an explanatory drawing showing a cross-sectional view of the bush after the power supply cord bush is attached to the chassis wall.

FIG. 7 is the same as above, and is an explanatory drawing showing the relationship between the bush insertion section and the chassis notch.

FIG. 8 is the same as above, and is an explanatory drawing showing the state after the power supply cord bush is attached on the chassis wall, and embedded in the body.

FIG. 9 illustrates the second preferred Embodiment of the present invention, and is an explanatory drawing showing the chassis unit comprising roughly a single body by attaching the electronic circuit substrate of the television image receiver and the DVD unit to the chassis having the power supply cord securement structure.

FIG. 10 illustrates the conventional securement structure, and is an explanatory drawing showing the state prior to attaching the power supply cord bush to the body.

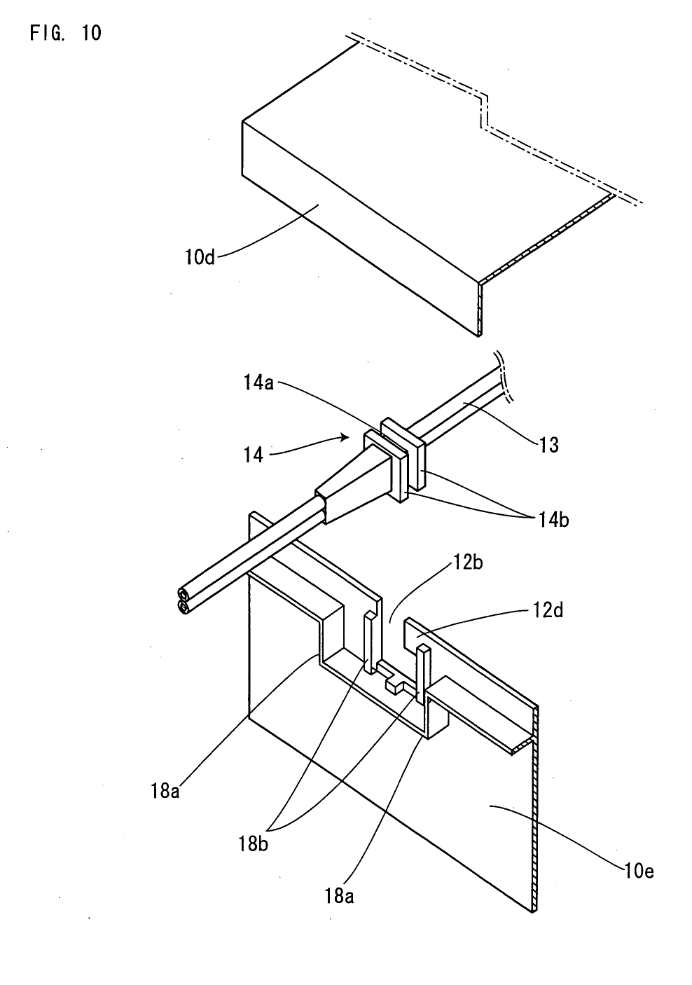

### DETAILED DESCRIPTION OF THE PREFERRED EMBODIMENTS

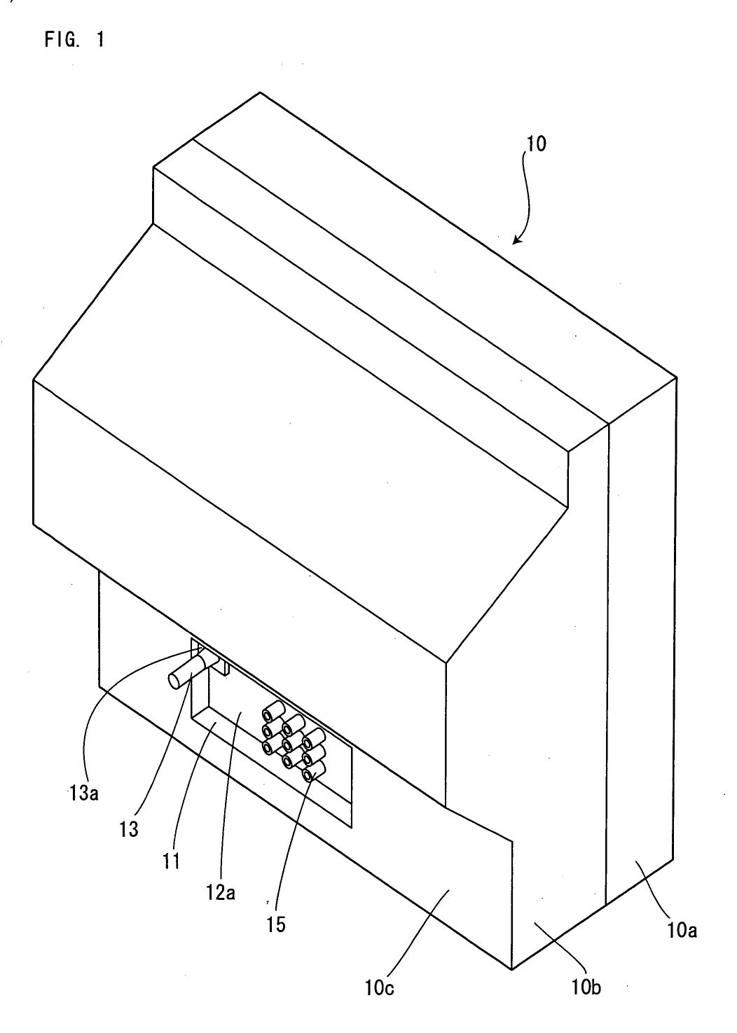

A preferred Embodiment for executing the present invention is described hereafter, with reference to the drawings. In Embodiment 1, FIG. 1 is a view from the rear of the television image receiver comprising the electronic device of the present invention, and is a diagonal view where an AV jack terminal 15 used for connecting to an external sound device such as a VTR, ground terminal (illustration omitted) or the like is mounted onto the chassis wall 12a, arranged to be exposed from the opening 11 of the wall 10c of the rear body 10b of the television image receiver. A securement structure 13a of the power supply cord where the notch of the present invention is formed at a part of the chassis wall 12a, is provided, the supporting brim of the power supply cord bush being constrained and secured by the edge of opening of the rear body.

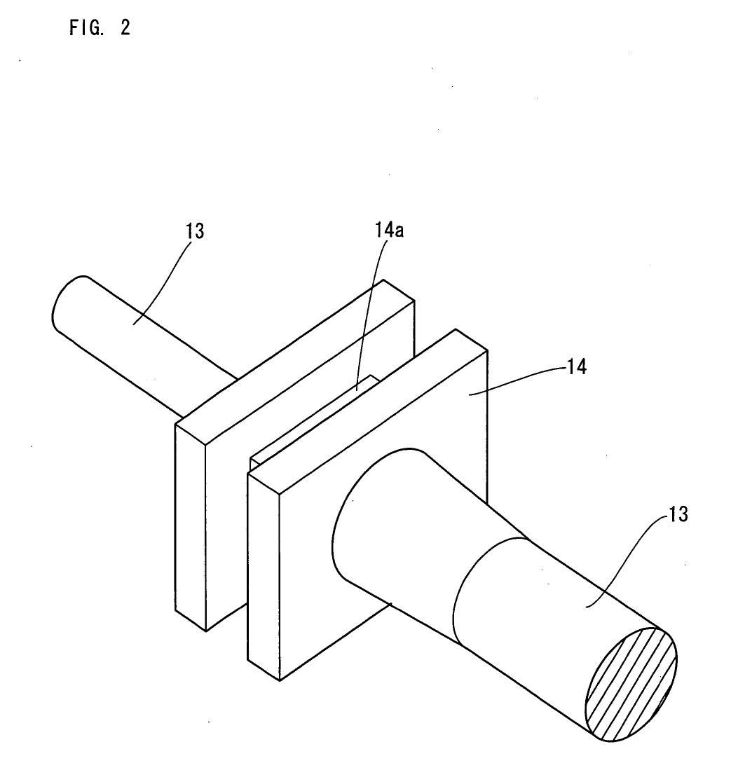

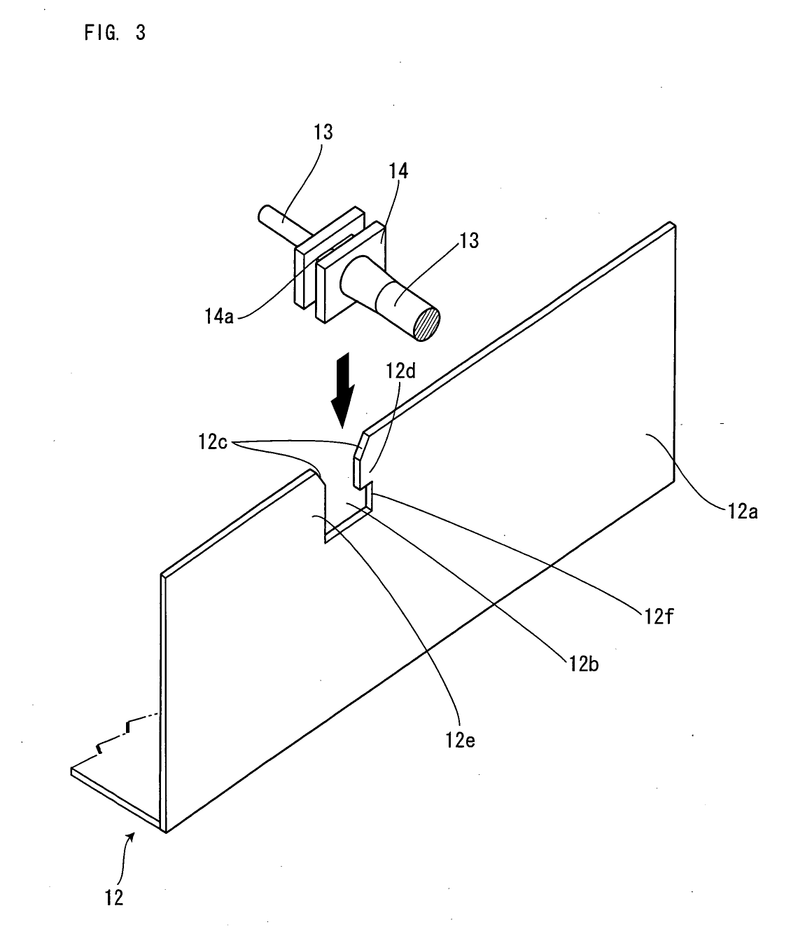

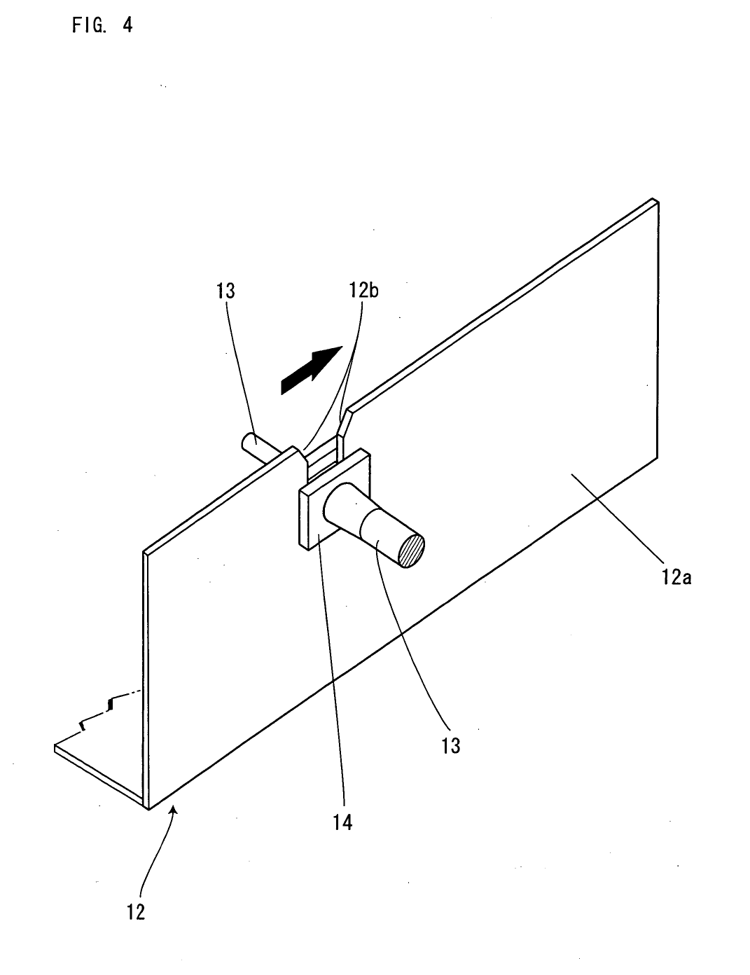

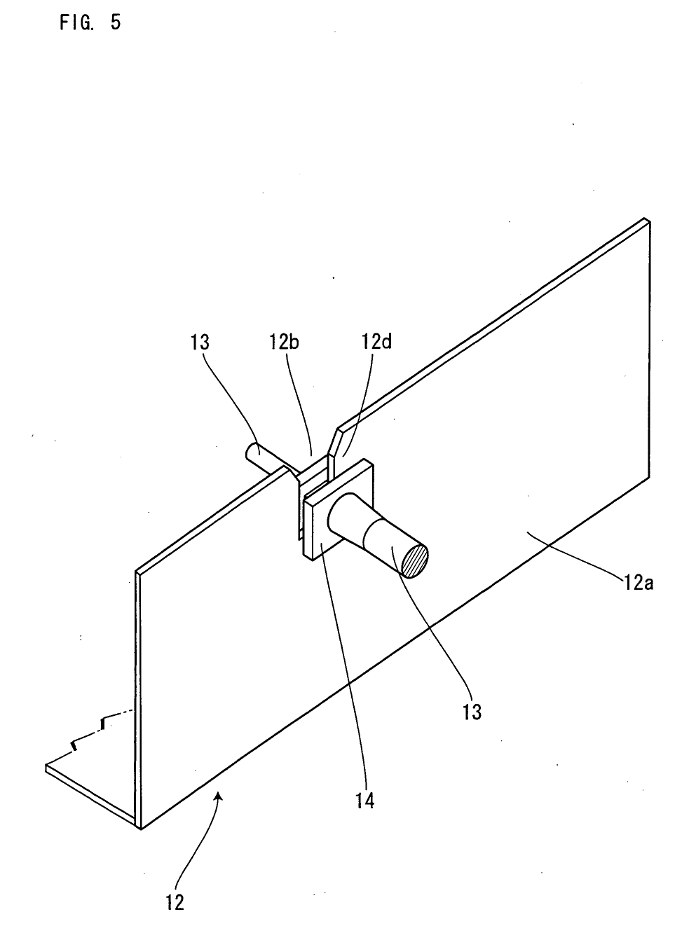

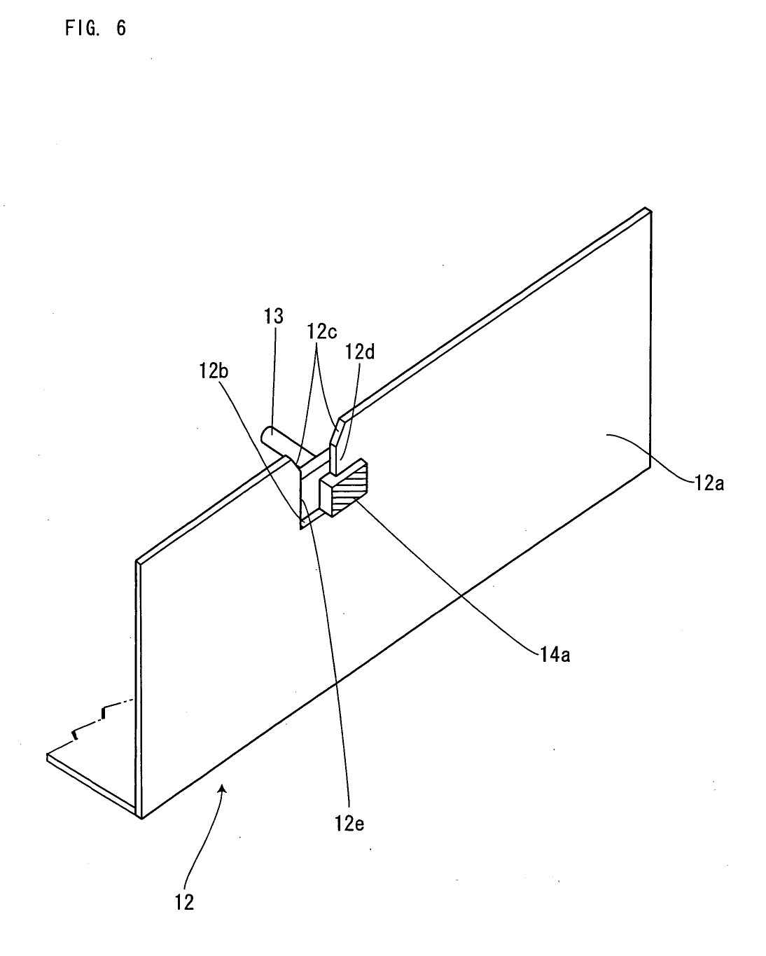

Successive descriptions shall be given in order. FIG. 2 is a magnified diagonal view of elements of the power supply cord that illustrates the construction of the bush provided on the power supply cord. In the power supply cord 13, a depressed section 14a is formed at nearly the center of the thickness of bush 14. FIG. 3 is a diagonal view of the power supply cord prior to its being secured to the wall of the rear side of the chassis, and FIG. 4 is a diagonal view showing the power supply cord attachment process. FIG. 5 is a diagonal view showing where the power supply cord is secured on the chassis. FIG. 6 is a cross-sectional view of the bush when the power supply cord is attached and fixed. The depressed section 14a of the bush is inserted to the deepest part of the nearly L shaped notch 12b arranged on the wall 12a of the chassis where the electronic circuit substrate (illustration omitted) is attached. Bush 14 of the power supply cord 13 is inserted and detachably secured to the notch 12b of the chassis wall 12a in the order shown in FIG. 3, FIG. 4, and FIG. 5. Assembling the chassis where the electronic circuit substrate and the power supply cord are attached as a single unit contributes to the efficiency of the assembly operation. Because the transfer between processes and transport between factories can be performed with the power supply cord in a secured state, stress related cutting and wearing during distribution can be prevented.

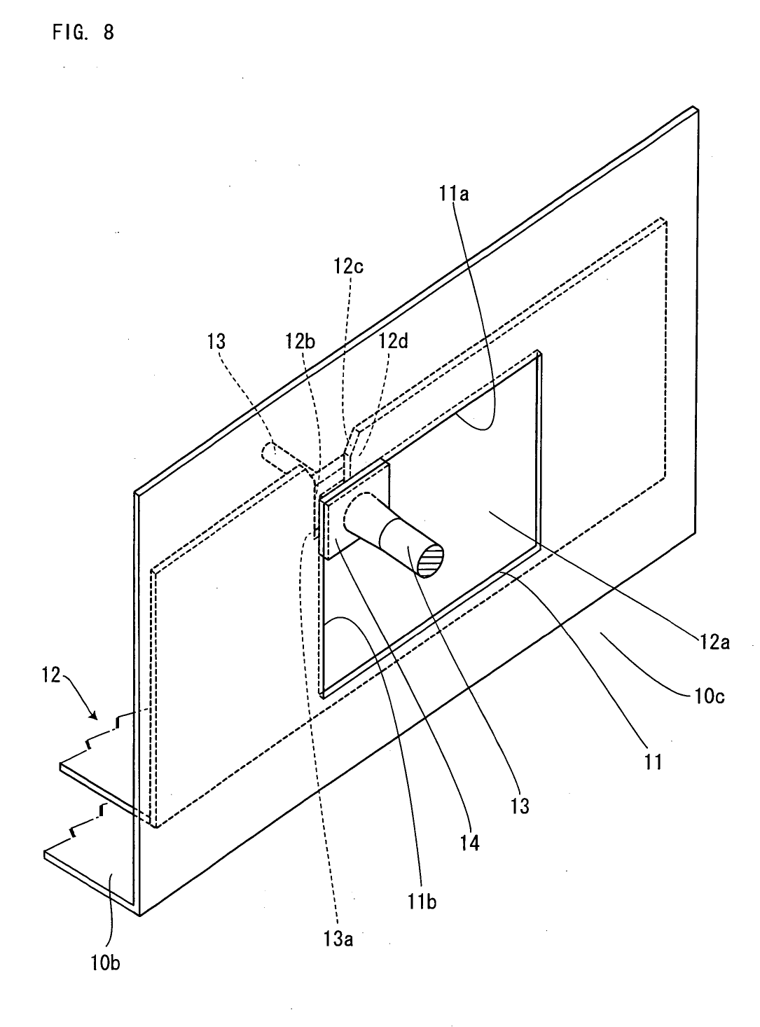

FIG. 8 is a relative position drawing where the bush 14 of the power supply cord is assembled onto body wall 10c in a state in which it is secured state to the chassis wall 12a in the final television image receiver assembly process. The direction of release of part 12c of the notch 12b formed on the chassis is obstructed by the upper edge 11a and the side edge 11b of the opening 11 of the rear body 10b, securing the bush and preventing it from slipping out. Even when the chassis 12 and the electronic circuit substrate (illustration omitted) need to be detached, the chassis wall 12a of the internal body can be exposed by only removing the rear body 10b, and the power supply cord 13 can maintain its state of being detachably secured to the notch 12b on the chassis wall 12a. Further, even when again assembled as a final product, there is no need to further handle the securement structure.

A more detailed account is given in FIG. 3 showing where the upper edge of the chassis wall 12a is open, with a notch being provided downward from the open section 12c. A nearly L shaped notch 12b is formed and notched in the lateral direction. A depression 14a is formed in the power supply cord 13 close to the center of the thickness of the bush 14. Subsequently, in order to insert the depression 14a provided close to the center of thickness of power supply cord 13 bush 14 into notch 12b provided on the chassis wall 12a from the open section 12c of the upper edge, the bush 14 enters the inner part by laterally moving the bush 14 in the direction shown in FIG. 4. Then, bush 14 of the power supply cord 13 inserted to the deepest part of the notch, according to FIG. 5, is secured to the chassis wall 12a by holding it between the upper part 12d of the chassis wall 12a and the bottom of the notch. When removing the power supply cord 13 bush 14 from the chassis wall 12a, the power supply cord 13 is removed from the chassis wall 12a by moving, in reverse order, the bush 14 to the opening section 12c of the notch within the notch 12b on the chassis wall 12a.

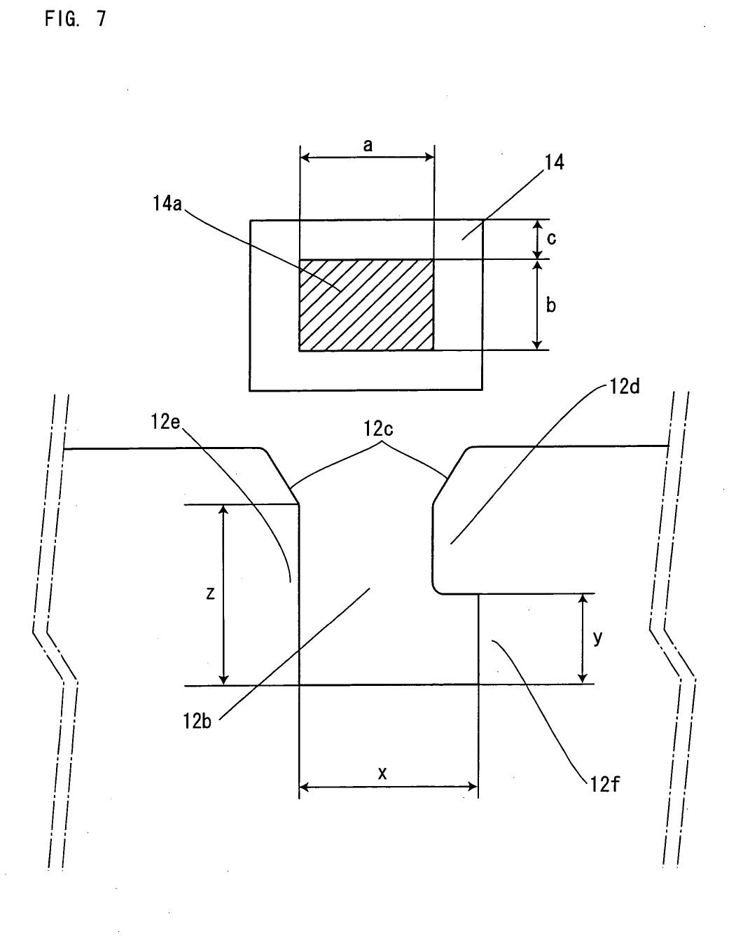

The present Embodiment demonstrates the results of comparing efficiencies in a secured state by assuming the level of vibration sustained during the transfer of processing and transport between factories after the bush 14 is inserted into the notch 12b. The shape of the bush 14 of the power supply cord 13 is ordinarily prepared in advance. FIG. 7 shows the lateral measurement and the vertical measurement of the depressed section 14a of the bush as a and b respectively, with the height of the supporting brim being represented as c, which are handled as secure values. On the other hand, if the lateral measurement is denoted as x and the vertical measurement of the interior side edge as y, and the vertical measurement of the opening side edge of the notch is denoted as z in measuring the insertion, with the bush in the notch 12b of the chassis, because secured efficiency cannot be expected if the bush is able to easily move even when the bush is inserted to the deepest part of the notch, the vertical measurement of the interior side edge of the notch y is pre-established to nearly the same measurement as that of the vertical measurement of the depressed section of the bush b. In other words, y is approximately equal to b. In addition, comparatively soft natural plastics, even at normal temperatures, are usually used in forming the bush 14, and increasing the security for preventing slipping out at the time of securing the cord can be achieved by adjusting the vertical measurement y of the interior side edge of the notch to a slightly smaller size than the vertical measurement b of the bush depressed section although insertion resistance will be slightly increased. Further, in the relationship between the opening depth of the chassis and the bush, the vertical measurement of the opening side edge of the chassis notch z, the vertical measurement of the bush depressed section b, and the height measurement of the supporting brim, are set to be b+c=z in order to prevent the bush from coming off easily, even if the bush is moved from the deepest part of the notch and tilted slightly, and also in order to prevent the open section of the chassis to be exposed by the gap at the edge of the open section of the body when the bush is secured in the deepest part of the notch and assembled as a final product. On that assumption, the ratio of the lateral measurement x of the chassis notch in relation to the lateral measurement of the depressed section a of the bush is combined by dividing the lateral measurement of the depressed section a of the bush into 6 steps from 1 time to 1.5 times and loads are added in three levels of vibrational strength: weak, medium, and strong; and the lateral measurement x of the chassis notch is compared so as to ascertain the appropriate ratio to the lateral measurement a of the depressed section of the bush. The results are shown in Table 1. In addition, the symbols expressed in the Table are as follows:
X: bush came off
Δ: insufficient to hold bush

◯: capable of holding bush

TABLE 1

| Vibration | | | |
|---|---|---|---|
| X | Weak | Medium | Strong |
| A | X | X | X |
| 1.1a | Δ | X | X |
| 1.2a | ◯ | Δ | Δ |
| 1.3a | ◯ | ◯ | ◯ |
| 1.4a | ◯ | ◯ | ◯ |
| 1.5a | ◯ | ◯ | ◯ |

As a result, the lateral measurement of the notch x formed on the chassis is generally 1.2 a=x=1.5 a. However, the holding state of the bush in the notch shape is more desirable when the lateral measurement of the notch x is wider. In other words, the deeper the depth in the lateral direction the better, and the conclusion is up to nearly double for practical use based on the arrangement restrictions of the rear body. Hence, relational formulas are obtained as a result, wherein:
the lateral measurement of the notch x formed on the chassis is generally 1.2 a=x=2 a, and preferably 1.4 a=x=1.7 a and more preferably x is approximately equal to 1.6 a.

In FIG. 8, the position of the securement structure 13a of the power supply cord of the notch form arranged on the chassis wall 12a, the position of the bush 14 inserted to the deepest part of the notch 12b, and the relative position between the upper edge 11a and the side edge 11b of the body opening section 11 provided in order to prevent the bush 14 from slipping off are pre-established, and the opening section 12c direction of the notch in the chassis and the opening side edge 12e direction are obstructed by the upper edge 11a and the side edge 11b of the body opening section, so that the bush does not come off by moving it to the open side of the notch in the chassis. Hence, arrangement is made to hold down the movement of the bush. However, the objective of preventing the power supply cord from slipping off can be achieved by obstructing only the open section 12c direction of the notch in the chassis with the upper edge 11a of the open section of the body.

According to the present Embodiment, by providing a power supply cord securement structure on the chassis, detachably securing the power supply cord is easily achieved in the assembly process, preventing stress related cutting and wear of the power supply cord during transport between factories and transfer during the assembly process. Further, the power supply cord securing structure can be obtained when the body of an electronic device is separate in the final product assembly stage, making a power supply cord securement means and the related operational man-hours to be unnecessary.

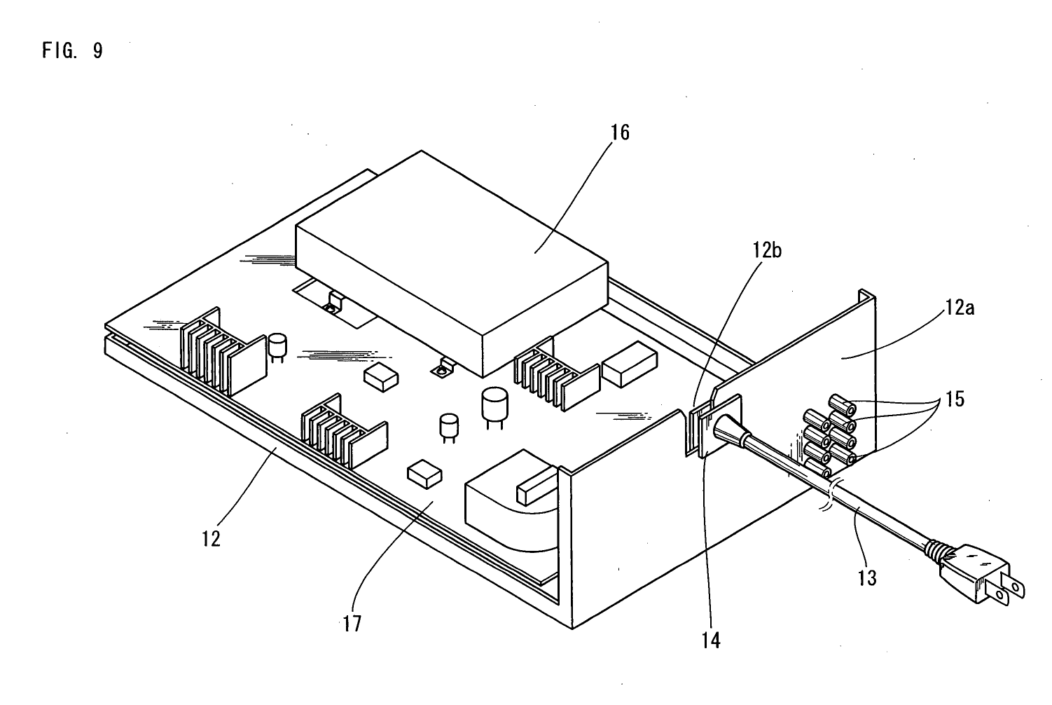

Embodiment 2 is a power supply cord securement structure used for a compound electronic device made by pre-forming a nearly L shaped notch 12b on the wall 12a of the chassis 12 used for a compound electronic device where the DVD unit 16 built-in to the electronic device as shown in FIG. 9 is mounted together with the electronic circuit substrate 17, and securing the bush 14 of the power supply cord 13 connected to the electronic circuit substrate 17 is accomplished by inserting it into the notch 12b, thereby preventing stress related cutting and wear of the power supply cord that occur during transport between factories and transfer during processing. By so doing, another electronic device unit built-in with the electronic circuit substrate 17, for instance DVD unit 16, is attached to the chassis wall 12a having the power supply cord 13 securement structure 13a, and can be treated as a single unit at the time of body assembly.

The present Embodiments are described above. However the present invention is not restricted to the aforementioned Embodiments, and various modification implements are possible within the range of the summary of the present invention. For instance, on the open side of the electronic device body, in the locations of the securement structure of the power supply cord provided as an annex to the wall where the chassis is formed, various jack terminals, and the ground terminal are not limited to the rear surface of the body, and may be provided at the side surface. Further, the open section of the nearly L shaped notch may be arranged in any direction of top, below, right or left in order to secure the power supply cord accordance, with convenience of the arrangement of the chassis and the body wall, and the deepest part of the notch can be modified to become nearly round or nearly rectangular in shape depending upon the bush shape.

Furthermore, the chassis notch and its location can be improved, such as increasing the anti-deflection strength by providing a rib and folding a chassis edge in the width of a few millimeters. In addition, even the electronic device in the present invention may be a video, DVD, HDD or the like, besides a television image receiver, and devices such as other electronic devices embedded into the electronic devices are not restricted to the aforementioned Embodiments, and may be appropriately selected.

1. An electronic device that provides a securement structure power supply cord, characterized by being provided with a nearly L shaped notch formed on the wall of the chassis attached to an electronic circuit substrate, wherein the bush of a power supply cord connected to the electronic circuit substrate is detachably secured through a notch.

2. An electronic device that provides a securement structure power supply cord characterized by the fact that, when the lateral measurement of the nearly L shaped notch formed to said chassis wall is x, and the vertical measurement of the opening side opposite edge is z, and the vertical measurement of the interior side edge is y, and the lateral measurement of the depressed part provided in the vicinity of the power supply cord bush inserted through the notch is a, and the vertical measurement is b, and the supporting brim height measurement is c, then y is approximately equal to b, and with a relationship wherein b+c≦z, and a relational formula where x and a are generally 1.2 a≦x≦2 a, and preferably 1.4 a≦x≦1.7 a and preferably x is approximately equal to 1.6 a.

3. An electronic device that provides the securement structure power supply cord described in claim 1, wherein: by attaching a chassis to the electronic device body in which the bush of said power supply cord is inserted, the bush is prevented from slipping out by obstructing the release direction of the notch formed on the chassis by the edge of the opening formed in the body wall of the electronic device.

4. An electronic device that provides the securement structure power supply cord described in claim 2, wherein: by attaching a chassis to the electronic device body in which the bush of said power supply cord is inserted, the bush is prevented from slipping out by obstructing the release direction of the notch formed on the chassis by the edge of the opening formed in the body wall of the electronic device.
